(19) United States
(12) Patent Application Publication
(10) Pub. No.: US 2017/0129212 A1
(43) Pub. Date: May 11, 2017

(54) WORKPIECE OF PARTIALLY HARDENED SHEET STEEL

(71) Applicant: GM GLOBAL TECHNOLOGY OPERATIONS LLC, Detroit, MI (US)

(72) Inventors: Hartmut BAUMGART, Ruesselsheim (DE); Ronald SANDERS, Ruesselsheim (DE)

(73) Assignee: GM GLOBAL TECHNOLOGY OPERATIONS LLC, Detroit, MI (US)

(21) Appl. No.: 15/347,283

(22) Filed: Nov. 9, 2016

(30) Foreign Application Priority Data
Nov. 10, 2015 (DE) 102015014489.8

(51) Int. Cl. B32B 15/01; B32B 7/08; B21J 15/04; B32B 3/26; B32B 15/18; B23K 11/11; B32B 7/04

(52) U.S. Cl. CPC B32B 15/011; B23K 11/11; B32B 7/08; B32B 7/045; B32B 3/266; B32B 15/18; B21J 15/04; B32B 2250/02; B32B 2307/536; B32B 2605/08

(57) ABSTRACT

A workpiece of sheet steel has a surface, which locally includes regions that are hardened by alloying in an additional element, as well as unhardened regions. At least one hardened region extends between a crack starting zone and an unhardened region.

### CROSS-REFERENCE TO RELATED APPLICATION

This application claims priority to German Patent Application No. 102015014489.8, filed Nov. 10, 2015, which is incorporated herein by reference in its entirety.

### TECHNICAL FIELD

The present disclosure pertains to a workpiece of sheet steel, the surface of which locally includes regions that are hardened by alloying in an additional element, as well as unhardened regions.

### BACKGROUND

DE 196 50 258 A1 describes a method, in which the wear resistance of the surface of a steel sheet is locally increased in that hardened regions are produced in the steel sheet by feeding an additional element in the form of a rod or wire to the steel sheet and alloying in the additional element by locally heating the steel sheet with the aid of a laser.

The distribution of the hardened regions on the surface of the steel sheet is not described in DE 196 50 258 A1 because the regions of the surface, in which such a coating is required, are in each individual instance defined by the respective distribution of the frictional stress.

### SUMMARY

The present disclosure develops a workpiece of sheet steel, in which the stability under loads, particularly the stability under tensile loads, is increased by local hardening. Such workpieces can be advantageously used, in particular, in the construction of car bodies in order to improve the strength of a car body or to reduce the weight of a car body with unmodified strength and thereby lower the material input and the fuel consumption.

Sheet metal workpieces installed into an end product such as, e.g., a car body are subjected to a load pattern that is characteristic for their installation position. When the forces acting upon the sheet metal workpiece exceed its load limit, the workpiece begins to tear at a highly stressed location, usually on its edge. As soon as the crack formation has started, the load is concentrated at the tip of the crack and the crack quickly propagates until it reaches an opposite edge of the workpiece.

According to an embodiment of the present disclosure, a workpiece of sheet steel having a surface which locally includes regions that are hardened by alloying in an additional element, as well as unhardened regions. At least one hardened region extends between a crack starting zone and an unhardened region. Since the hardened region absorbs a relatively large portion of the tensile load, it decreases the load acting upon the crack starting zone and thereby counteracts the crack formation.

In practical applications, the crack starting zone may be formed, e.g., by a notch in an edge of the workpiece. In order to decrease the load acting upon the notch, the hardened region should extend along the edge and around the notch.

If the crack starting zone does not lie on the edge of the workpiece, it is frequently formed by a hole or a concavity, e.g. a concavity that accommodates the widened end of a punch rivet, by means of which the first workpiece is riveted to a second workpiece. In this case, the hardened region can advantageously extend around the crack starting zone.

The edge facing the crack starting zone and an edge of the same or a second hardened region facing away from the crack starting zone preferably define a strip-shaped unhardened region, in which the crack can propagate. It is furthermore advantageous if several strip-shaped unhardened regions intersect the line. Even if a crack manages to propagate from one of the unhardened regions into a hardened region, it is therefore very likely that this crack is intercepted and once again deflected sideward by an unhardened region lying behind.

The hardened region preferably forms a closed ring around the crack starting zone. The crack starting zone may generally be formed by a fastening point of the second workpiece on the first workpiece because forces, which are transmitted from the second workpiece to the first workpiece at the fastening point, can lead to overstressing of the first workpiece regardless of the fastening method used and therefore cause cracks to form starting from the fastening point.

According to another preferred embodiment of the present disclosure, an edge of the hardened region facing the crack starting zone intersects a line, which extends from the crack starting zone to a distant edge of the workpiece referred to the crack starting zone, at an oblique angle. If the crack formation has already started, this feature may potentially make it possible to still prevent a complete failure of the workpiece, but can at least significantly increase the energy absorbed by the workpiece up to its complete failure, namely in that the crack being formed is deflected sideward when it encounters the edge of the hardened region. In this way, at least the length reached by the crack up to the complete failure of the workpiece is extended and the energy, which has to be exerted for the crack formation up to the failure of the workpiece, is therefore increased.

In order to enable the edge of the hardened region to deflect a propagating crack, it cannot extend parallel to the connecting line between the crack starting zone and the edge of the workpiece, but should also not extend perpendicular to this line. A particularly suitable angle between edge and line lies between 30° and 60°, preferably between 40° and 50°.

### BRIEF DESCRIPTION OF THE DRAWINGS

The present disclosure will hereinafter be described in conjunction with the following drawing figures, wherein like numerals denote like elements.

FIG. 1 shows a top view of a workpiece according to a first embodiment of the present disclosure;

FIG. 2 shows a top view of a workpiece according to a second embodiment;

FIG. 3 shows a section through two workpieces according to a third embodiment;

FIG. 4 shows a perspective view of two workpieces according to a fourth embodiment; and

FIG. 5 shows a top view of a workpiece according to a fifth embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

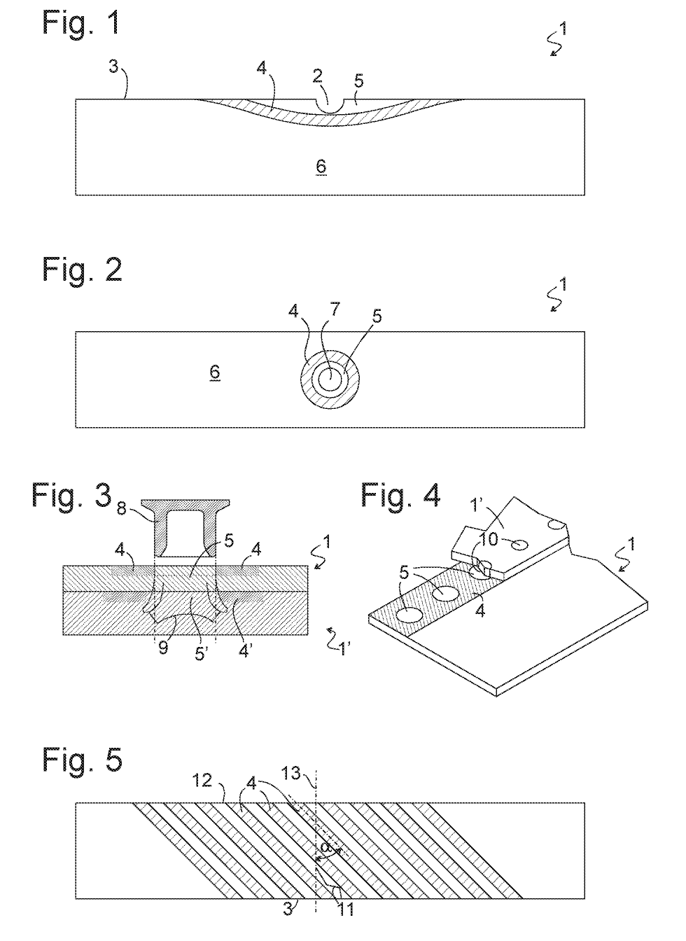

The present disclosure can be applied to workpieces of any shape. The workpieces may be flat or three-dimensionally shaped and their edges may have any profile. Consequently, the workpieces in the form of rectangular sheet metal strips, which are illustrated in the figures and described below, merely represent examples. Accordingly, the special features, e.g. a notch 2 in an elongate edge 3 of the workpiece 1 shown in FIG. 1 may just as well be present in workpieces of any other shape.

In a conventional metal sheet with homogenous material properties, a crack would start to form at the notch 2 when the metal sheet is subjected to a high tensile load. Such a crack would ultimately propagate from the notch 2 to an opposite edge of the metal sheet causing the metal sheet to be torn into two pieces.

Accordingly to the present disclosure, the workpiece 1 has a hardened region 4 produced along the edge 3 by alloying in a hardening additional element. This alloying process may be realized by laser alloying as described in initially cited document DE 196 50 258 A1 or by the method disclosed in DE 10 2014 010 660.8 and therefore is not described herein greater detail at this point. The hardening additional elements to be alloyed in may consist, e.g., of carbon, nitrogen, manganese, silicon, nickel or chromium. The hardened region 4 extends along the edge 3 to both sides of the notch 2 and around the notch 2 in the form of a flat arc. Tensile stresses acting upon the ends of the workpiece 1 are diverted around the notch 2 and its unhardened immediate vicinity 5 by the hardened region 4. The tensile load, at which the crack formation starts at the notch 2, can thereby be significantly increased depending on the dimensions of the notch 2 and the hardened region 4 or potentially even no longer reached because the material would previously tear in the unhardened region 6 in front or behind the notch 2.

A corresponding effect is achieved on the workpiece 1 shown in FIG. 2 in that a hardened region 4 is annularly produced around a hole 7 in the unhardened vicinity 5. The weakening of the workpiece 1 caused by the hole 7 can be compensated or even overcompensated with the hardened region 4 such that the workpiece does not tear at the hole 7 when it is overstressed, but rather in the unhardened region 6 surrounding the annular hardened region 4.

FIG. 3 shows a section through two workpieces 1, 1′, both of which are provided with an annular hardened region 4, 4′ of the type illustrated in FIG. 3, but these workpieces are not perforated in their unhardened regions 5, 5′ that are respectively surrounded by the hardened regions 4, 4′. The region 5 of the upper workpiece 1 is provided for being punched out of the workpiece 1 by a semi-tubular punch rivet 8 sectionally illustrated on top thereof, as well as for being pushed in front of the punch rivet and pressed into the unhardened region 5′ of the workpiece 2′. During this penetration, the shaft of the semi-tubular punch rivet 8 ideally widens in such a way that it engages behind the hardened region 4′ within the workpiece 1′; the strength of the thusly produced positive connection benefits from the strength of the surrounding hardened region 4, 4′.

In a homogenous metal sheet that is subjected to a tensile load, the concavity 9 produced in the workpiece 1′ due to the penetration of the rivet 8 would form a starting point for the formation of a crack. However, the hardened region 4′ in this case also relieves the tension analogous to the embodiment illustrated in FIG. 2 such that the tension is diverted around the concavity 9 and a crack formation is prevented.

FIG. 4 shows a perspective view of two workpieces 1, 1′ that consist of flat metal sheets in this embodiment and are connected along their edges 3, 3′ by means of spot welds 10. The workpiece 1 is provided with a hardened region 4, in which regions 5 are recessed, along its edge 3. The spot welds 10 are respectively set in these unhardened regions 5 in order to utilize their superior welding properties in comparison with the hardened region 4. The stability of the welded joint under bending loads benefits from the fact that the hardened region reduces the resilience of the workpiece 1 under a bending moment acting upon the spot welds 10.

FIG. 5 once again shows a top view of a strip-shaped workpiece 1. Several strip shaped hardened regions 4 extend over the workpiece 1 obliquely to the edge 3, in this case at an angle of approximately 45°. Cracks propagating from the edge 3 into the workpiece 1 may form in the unhardened regions 5, 6 under high tensile stresses just like in a conventional workpiece with homogenous material properties. However, when such a crack 11 encounters the edge of a hardened region 4, its further propagation into this region 4 requires more energy than in instances, in which the crack 11 would continue to propagate within the unhardened region 5. The crack 11 therefore tends to follow the profile of the unhardened region 5. Consequently, the crack 11 becomes longer and consumes more energy up to the complete separation of the workpiece 1 than in an isotropic metal sheet of identical shape, in which the crack would respectively propagate from a starting edge 3 to an opposite edge 12 on the shortest path along a line 13.

In FIG. 5, the hardened and unhardened regions 4, 5 are so closely spaced apart that several of these regions respectively intersect the shortest line 13 between the two edges 3, 12. Even if the crack 11 should propagate through a hardened region 4, it is therefore possible to once again intercept the crack in a following unhardened region 5 and to deflect the crack obliquely to the line 13.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-9. (canceled)

10. A workpiece of sheet steel comprising a first unhardened sheet metal component having a surface with a crack starting zone, and a second sheet metal component having a local alloy-hardened region secured to the surface and extending between the crack starting zone and an unhardened region.

11. The workpiece according to claim 10, wherein the crack starting zone comprises a notch in an edge of the workpiece and the hardened region extends along the edge and around the notch.

12. The workpiece according to claim 10, wherein the crack starting zone comprises a hole and the hardened region extends around the hole.

13. The workpiece according to claim 10, wherein the crack starting zone comprises a concavity and the hardened region extends around the concavity.

14. The workpiece according to claim 10, wherein the hardened region comprises a closed ring encompassing the crack starting zone.

15. The workpiece according to claim 10, further comprising a fastening point in the crack zone, wherein the second sheet metal component is secured to the first sheet metal component at the fastening point.

16. The arrangement according to claim 15, wherein the fastening point further comprising a fastening element selected from the group consisting of a rivet, a spot weld, a screw connection or a combination thereof.

17. The workpiece according to claim 10, wherein an edge of the hardened region facing the crack starting zone intersects a line extending from the crack starting zone to distant edge of the first sheet metal component at an oblique angle

18. The workpiece according to claim 17, wherein the oblique angle lies between 30° and 60°.

19. The workpiece according to claim 18, further comprising a plurality of second sheet metal components characterized in that several strip-shaped secured to the surface and intersecting the line.
